(19) United States
(12) Patent Application Publication
(10) Pub. No.: US 2025/0381429 A1
(43) Pub. Date: Dec. 18, 2025

(54) FORCED COOLING DEVICE OF POWER STORAGE MODULE

(71) Applicant: Tachia Yung Ho Machine Industry Co., Ltd., Taichung City 437 (TW)

(72) Inventors: Shih-Feng Huang, Taichung City 437 (TW); Jun-Qiang Zeng, Taichung City 437 (TW)

(21) Appl. No.: 18/745,865

(22) Filed: Jun. 17, 2024

(51) Int. Cl. A62C 3/16; A62C 31/02; H01M 10/48; H01M 10/613; H01M 50/30; H01M 50/673

(52) U.S. Cl. CPC A62C 3/16; A62C 31/02; H01M 10/48; H01M 10/613; H01M 50/30; H01M 50/673

(57) ABSTRACT

In a forced cooling device of a power storage module, liquid carbon dioxide is mainly utilized to function as a flame retardant, combustion can also be reduced by replacing oxygen, a burning surface can also be cooled to avoid further damages, and a gas detection device can quickly detect abnormal conditions of a battery cabinet and a battery module, and perform fastest cooling, and flame retarding and extinguishing. After fire has been extinguished, a battery cell is in a stabler state due to the low temperature, and flashover or high-temperature risks can be eliminated.

### BACKGROUND OF THE INVENTION

(1) Field of the Invention

The invention relates to a forced cooling device of a power storage module, and more particularly to a device which can perform fastest cooling, and flame retarding and extinguishing, wherein after fire has been extinguished, the battery cell is in a stabler state due to the low temperature, the safety is higher when manual troubleshooting is being performed, and flashover or high-temperature risks can be eliminated.

(2) Description of the Prior Art

Recently, electric scooters are rapidly developed, and some of the electric scooters work by way of battery exchanging. In order to facilitate the public to replace batteries, most battery swap stations are set up at hotspots such as gas stations, stores and the like, to provide the users of the electric scooter with the convenient battery replacement. Lithium batteries with the larger capacities are used as the electric power in the electric scooters to keep the longer endurance. So, when the electric power is not sufficient, the user drives the electric scooter to the battery swap station and replaces the used battery with a charged lithium battery. A lot of batteries are placed in the energy storage cabinet, and the batteries generate a lot of thermal energy or even cause fire in the charge/discharge process. At present, most service providers use total flooding to reduce the environment oxygen content, or use total flooding sprinkling to lower the temperature. The total flooding can only extinguish the electrical equipment fire and may not extinguish the battery module that has caught the fire, and the temperature of the thermal runaway battery module cannot be lowered. The total flooding sprinkling, which may extinguish the fire, cannot effectively cool the battery module that has caught fire, and may damage the peripheral apparatus and cause the greater property loss.

### SUMMARY OF THE INVENTION

The invention solves the problems by the technical characteristics mainly including a fire control box, in which a gas detection device and a forced cooling system are disposed. The forced cooling system includes a high-pressure liquid carbon dioxide cylinder set, and a drive valve connected to the high-pressure liquid carbon dioxide cylinder set, wherein liquid carbon dioxide is stored in the high-pressure liquid carbon dioxide cylinder set.

Therefore, the invention mainly uses the liquid carbon dioxide to provide the flame retardant function. Combustion can also be reduced by replacing oxygen. A burning surface can also be cooled to avoid further damages. The gas detection device can quickly detect abnormal conditions of a battery cabinet and a battery module, and perform fastest cooling, and flame retarding and extinguishing. After fire has been extinguished, the battery cell is in a stabler state due to the low temperature, and flashover or high-temperature risks can be eliminated.

### BRIEF DESCRIPTION OF DRAWINGS

FIG. 1 is a schematic structure view showing a forced cooling device of a power storage module of the invention.

FIG. 2 is a pictorial view showing a rear end surface of the forced cooling device of the power storage module of the invention.

FIG. 3 is a schematic view showing members of a battery cabinet of the invention and a battery module thereof.

FIG. 4 is a schematic top view showing members of the battery module of the invention.

FIG. 5 shows forced cooling performed on some of the battery modules of the invention.

FIG. 6 shows forced cooling performed on the battery cabinet of the invention.

FIG. 7 shows forced cooling performed on the battery cabinet in another embodiment of the invention.

### DETAILED DESCRIPTION OF THE INVENTION

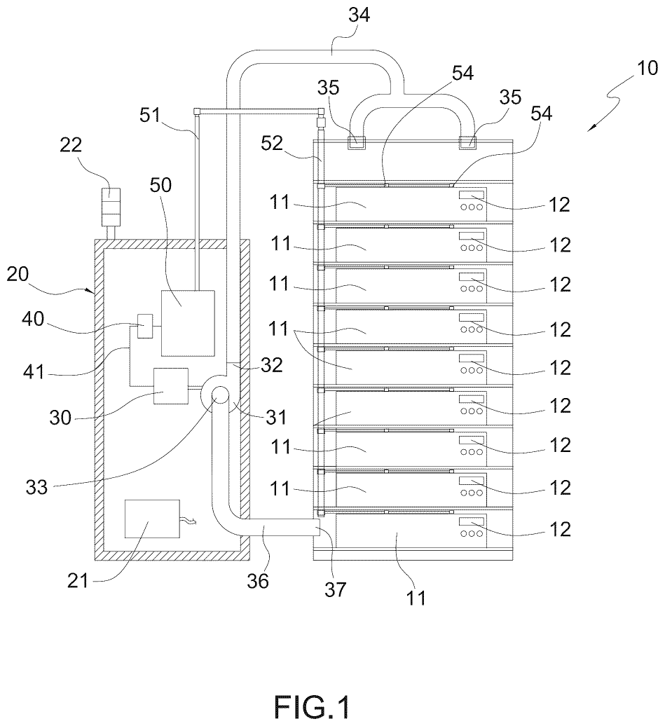

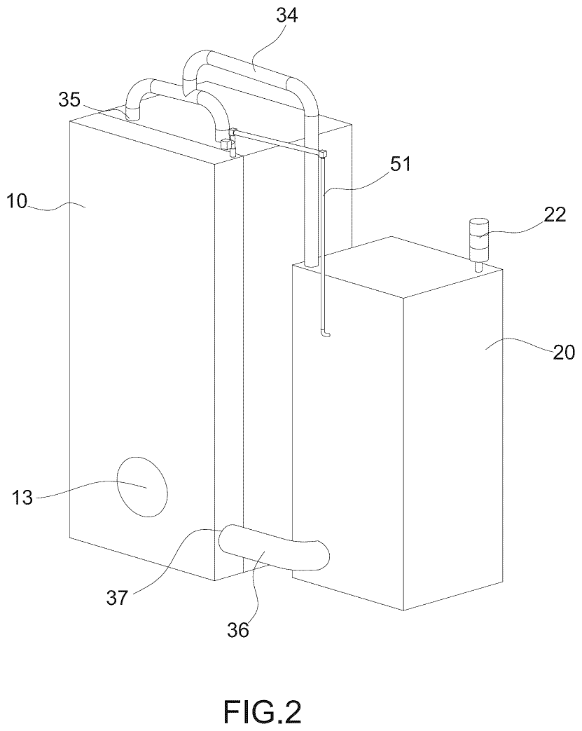

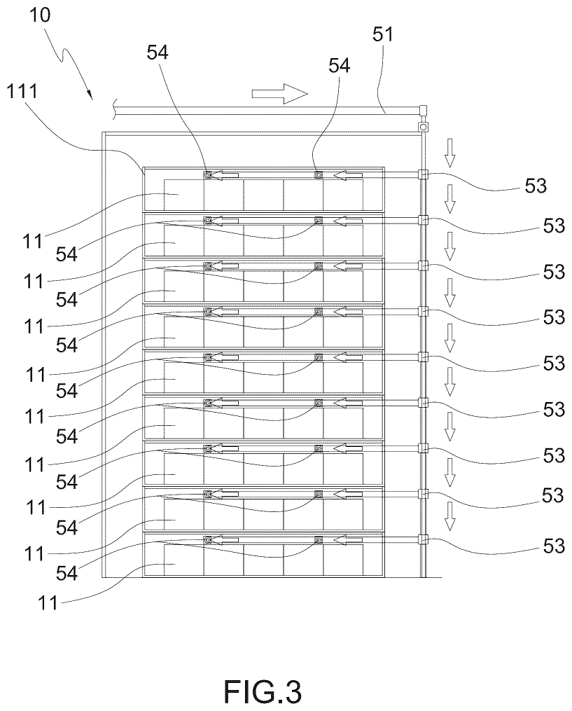

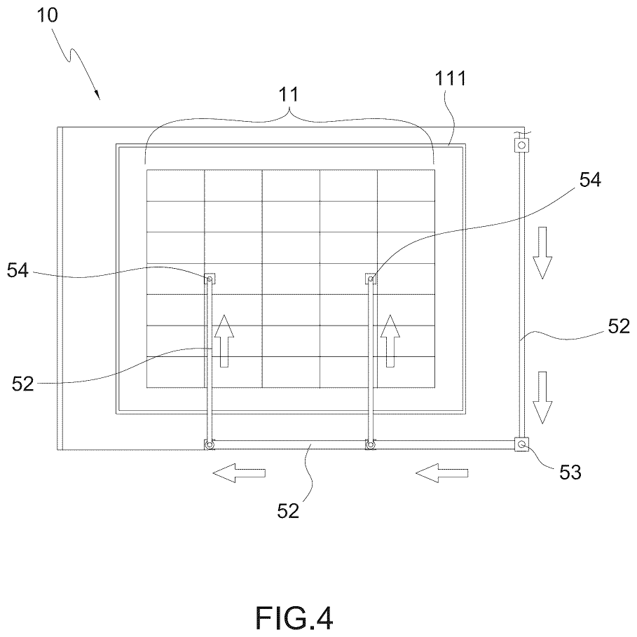

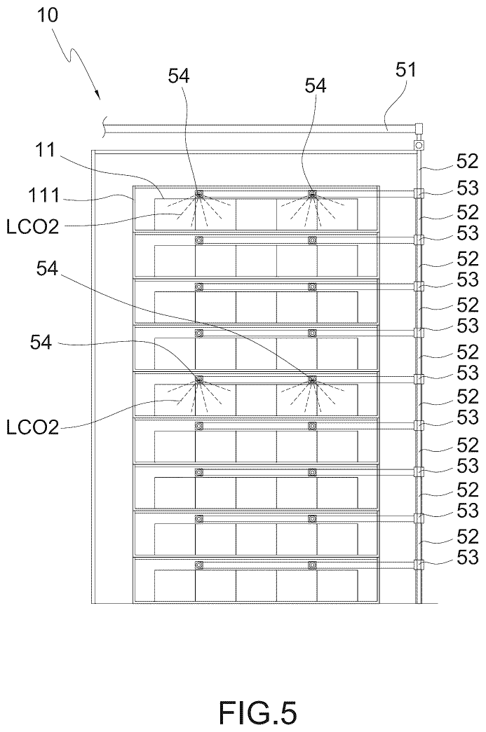

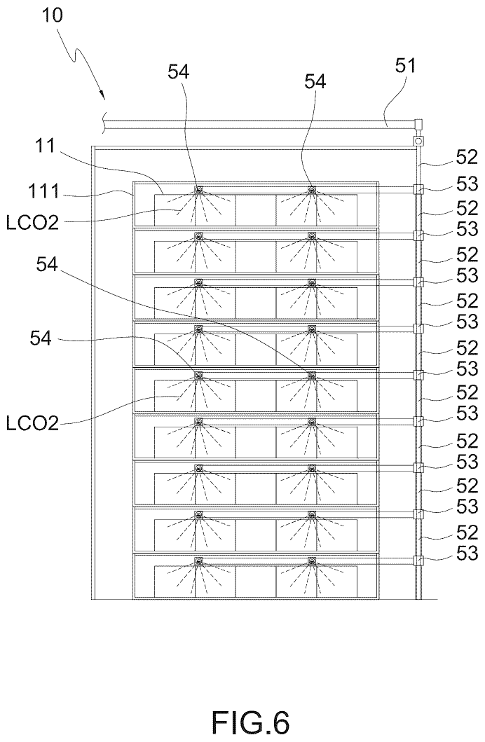

In order to make the examiner have a further in-depth understanding of this invention, preferred embodiments will be described with reference to FIGS. 1 to 7. A forced cooling device of a power storage module of the invention includes a battery cabinet 10, a fire control box 20 and a drive valve 40.

The battery cabinet 10 has longitudinal layers, on which multiple battery modules 11 are disposed. A battery management device 12 is disposed on one side of each of the battery modules 11. The battery cabinet 10 is provided with an intake terminal 35 and an exhaust terminal 37. An outer end surface of the battery cabinet 10 is provided with an exhaust port 13 to facilitate the emission of toxic gases.

A gas detection device 30 and a forced cooling system are disposed in the fire control box 20. The forced cooling system includes a high-pressure liquid carbon dioxide cylinder set 50. The gas detection device 30 is connected to a circulator 31, and senses whether the battery cabinet 10 becomes abnormal according to gas compositions collected by the circulator 31. In this embodiment, the circulator 31 is in a form of a blower. The circulator 31 has a first end 32 and a second end 33. The first end 32 is connected to one end of a first conduit 34, and the other end of the first conduit 34 is connected to the intake terminal 35 of the battery cabinet 10. The second end 33 is connected to one end of a second conduit 36, and the other end of the second conduit 36 is connected to the exhaust terminal 37 of the battery cabinet 10, so that the first conduit 34, an inside of the battery cabinet 10, the second conduit 36 and the circulator 31 form a closed loop. In addition, a battery management host 21 is disposed in the fire control box 20, and is electrically coupled to each of the battery management devices 12 in the battery cabinet 10. A warning device 22 is disposed outside the fire control box 20, and is electrically coupled to the gas detection device 30 and the battery management host 21. The warning device 22 is enabled when any one of the gas detection device 30 and the battery management host 21 becomes abnormal. The warning device 22 has the warning effects of warning light and a buzzer, and can remotely notify the mobile device of the user via Internet to operate the forced cooling system remotely.

The drive valve 40 is connected to the gas detection device 30 via a signal line 41, and is connected to the high-pressure liquid carbon dioxide cylinder set 50, in which liquid carbon dioxide LCO2 is stored. The liquid carbon dioxide LCO2 is a liquid formed from highly compressed and cooled gaseous carbon dioxide and is not formed under atmosphere conditions. The liquid carbon dioxide is present only when the pressure is higher than 5.1 atm, and the temperature is lower than the critical point temperature of 31.1° C. (88.0° F.) and higher than the triple point temperature of −56.6° C. (−69.9° F.). The liquid carbon dioxide LCO2 is transparent and odorless, and the liquid has the density of 1101 kg/m3 when becoming fully saturated at −37° C. (−35° F.). The liquid carbon dioxide LCO2 stored in the form of liquid under pressure may provide the flame retardant function, and can reduce the combustion by replacing the oxygen as well as cool the burning surface to avoid further damages.

The high-pressure liquid carbon dioxide cylinder set 50 has a high-pressure main conduit 51, which enters the battery cabinet 10, and has at least one high-pressure secondary conduit 52 corresponding to each of the battery modules 11. A distal end of the high-pressure secondary conduit 52 is inserted into (or enters) the battery module 11. A housing 111 houses the battery module 11, and the high-pressure secondary conduit 52 is inserted into the housing 111 and a high-pressure nozzle 54 thereof is disposed inside the housing 111. In addition, the distal end of the high-pressure secondary conduit 52 is provided with the high-pressure nozzle 54. A control valve 53 for controlling each of the high-pressure nozzles 54 to open and close is disposed on the high-pressure secondary conduit 52 at a position corresponding to each of the battery modules 11.

Therefore, when one of the battery modules 11 makes the battery management host 21 in the fire control box 20 receive an abnormal signal through the battery management device 12, the corresponding control valve 53 is opened, and the high-pressure nozzle 54 in the abnormal battery module 11 sprays the liquid carbon dioxide LCO2 from the high-pressure liquid carbon dioxide cylinder set 50 into the battery module 11 through the high-pressure main conduit 51 and the high-pressure secondary conduit 52. Furthermore, when the battery cabinet 10 makes the gas detection device 30 in the fire control box 20 receive an abnormal signal through the gas detection of the first conduit 34 and the second conduit 36, all the control valves 53 are opened, and the high-pressure nozzles 54 corresponding to all the battery modules 11 disposed in the whole battery cabinet 10 spray the liquid carbon dioxide LCO2 from the high-pressure liquid carbon dioxide cylinder set 50 into all the battery modules 11 of the overall battery cabinet 10 through the high-pressure main conduit 51 and the high-pressure secondary conduit 52.

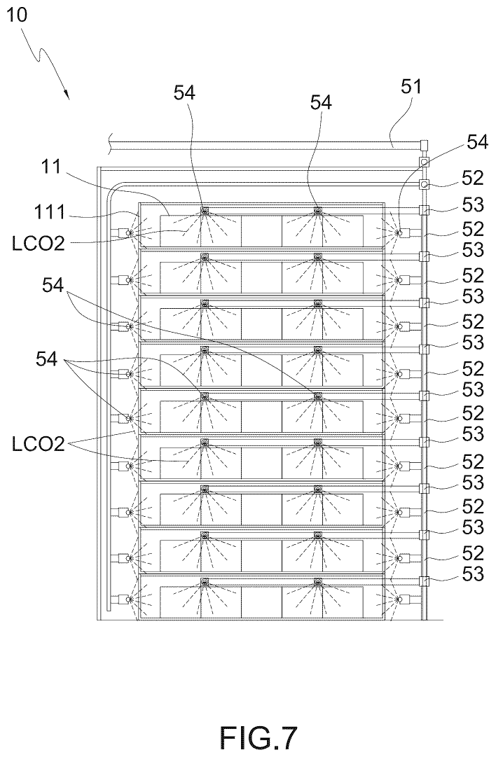

Referring to FIG. 7 showing another embodiment of the invention, the high-pressure secondary conduit 52 may be provided with a high-pressure nozzle 54 corresponding to the outer wall surface of the housing 111 of each of the battery modules 11, so that the outer cooling and the inner cooling can be performed on the battery modules 11 in the battery cabinet 10 to achieve the best cooling effect.

What is claimed is:

1. A forced cooling device of a power storage module, comprising:
a battery cabinet having longitudinal layers, on which multiple battery modules are disposed, wherein a battery management device is disposed on one side of each of the battery modules, and the battery cabinet is provided with an intake terminal and an exhaust terminal;
a fire control box, in which a gas detection device and a forced cooling system are disposed, wherein the forced cooling system comprises a high-pressure liquid carbon dioxide cylinder set; wherein the gas detection device is connected to a circulator, the circulator has a first end and a second end, the first end of the circulator is connected to one end of a first conduit, the other end of the first conduit is connected to the intake terminal of the battery cabinet, the second end of the circulator is connected to one end of a second conduit, and the other end of the second conduit is connected to the exhaust terminal of the battery cabinet, so that the first conduit, an inside of the battery cabinet, the second conduit and the circulator form a closed loop; wherein a battery management host is disposed in the fire control box and is electrically coupled to each of the battery management devices in the battery cabinet; and
a drive valve, which is connected to the gas detection device via a signal line, and is connected to the high-pressure liquid carbon dioxide cylinder set, in which liquid carbon dioxide is stored, wherein the high-pressure liquid carbon dioxide cylinder set has a high-pressure main conduit, which enters the battery cabinet, and has at least one high-pressure secondary conduit corresponding to each of the battery modules, wherein a distal end of the high-pressure secondary conduit is inserted into the battery module, and a high-pressure nozzle is disposed at the distal end of the high-pressure secondary conduit, wherein a control valve for controlling each of the high-pressure nozzles to open and close is disposed on the high-pressure secondary conduit at a position corresponding to each of the battery modules.

2. The forced cooling device of the power storage module according to claim 1, wherein: a warning device is disposed outside the fire control box and is electrically coupled to the gas detection device and the battery management host; and the warning device is enabled when any one of the gas detection device and the battery management host becomes abnormal, the warning device has warning effects of warning light and a buzzer, and can remotely notify a mobile device of a user via Internet to operate the forced cooling system remotely.

3. The forced cooling device of the power storage module according to claim 1, wherein the circulator is in a form of a blower.

4. The forced cooling device of the power storage module according to claim 1, wherein an outer end surface of the battery cabinet is provided with an exhaust port.

5. The forced cooling device of the power storage module according to claim 1, wherein a housing houses the battery modules, and the high-pressure secondary conduit is inserted into the housing, and the high-pressure nozzle is disposed inside the housing.
